(19) United States
(12) Patent Application Publication
(10) Pub. No.: US 2024/0230897 A1
(43) Pub. Date: Jul. 11, 2024

(54) PHOTODETECTOR AND PHOTODETECTION SYSTEM

(71) Applicant: SONY SEMICONDUCTOR SOLUTIONS CORPORATION, KANAGAWA (JP)

(72) Inventors: TAKAHIRO IDA, KANAGAWA (JP); SHIN MATSUMOTO, KANAGAWA (JP); NAOKI WATANABE, KANAGAWA (JP)

(21) Appl. No.: 18/557,670

(22) PCT Filed: Feb. 2, 2022
(86) PCT No.: PCT/JP2022/004041

§ 371 Date: Oct. 27, 2023

(30) Foreign Application Priority Data
May 17, 2021 (JP) 2021-083437

(51) Int. Cl. G01S 17/08; G06T 5/40

(52) U.S. Cl. CPC G01S 17/08; G06T 5/40

(57) ABSTRACT

A photodetector according to the present disclosure includes: a light-receiving circuit including a light-receiving element, and being configured to detect a light pulse reflected by a detection target among light pulses emitted from a light-emitting section; a conversion circuit being configured to calculate a digital value corresponding to a light-receiving timing in the light-receiving circuit; a histogram generation circuit being configured to generate a first histogram on a basis of the digital value; a correction processing circuit being configured to generate a second histogram by performing correction processing on the first histogram using a light-receiving characteristic that is asymmetric in a direction of a time axis in the light-receiving element; and a calculation circuit being configured to calculate a representative value of the light-receiving timing on a basis of the second histogram.

### TECHNICAL FIELD

The present disclosure relates to a photodetector and a photodetection system that detect light.

### BACKGROUND ART

To measure a distance to a detection target, a time-of-flight (ToF) method is often used. In the ToF method, light is emitted, and reflected light reflected by the detection target is detected. In the ToF method, a time difference between a timing of emitting light and a timing of detecting reflected light is then measured to measure a distance to the detection target. NPTL 1 discloses, for example, a technique of performing correction processing on the basis of a histogram of a detection timing at which light is detected to remove an influence by a measurement error.

### CITATION LIST

### Non-Patent Literature

NPTL 1: T. Neimert-Andersson, “3D imaging using time-correlated single photon counting”, Doctoral thesis, Uppsala univ., 2010

### SUMMARY OF THE INVENTION

What is demanded for a photodetector is increased detection accuracy, and what is expected is further increased detection accuracy.

It is desirable to provide a photodetector and a photodetection system that make it possible to increase detection accuracy.

A photodetector according to an embodiment of the present disclosure includes a light-receiving circuit, a conversion circuit, a histogram generation circuit, a correction processing circuit, and a calculation circuit. The light-receiving circuit includes a light-receiving element, and is configured to be able to detect a light pulse reflected by a detection target among light pulses emitted from a light-emitting section. The conversion circuit is configured to be able to calculate a digital value corresponding to a light-receiving timing in the light-receiving circuit. The histogram generation circuit is configured to be able to generate a first histogram on a basis of the digital value. The correction processing circuit is configured to be able to generate a second histogram by performing correction processing on the first histogram using a light-receiving characteristic that is asymmetric in a direction of a time axis in the light-receiving element. The calculation circuit is configured to be able to calculate a representative value of the light-receiving timing on a basis of the second histogram.

A photodetection system according to an embodiment of the present disclosure includes a light-emitting section and a photodetection section. The light-emitting section is configured to be able to emit light pulses. The photodetection section includes a light-receiving circuit, a conversion circuit, a histogram generation circuit, a correction processing circuit, and a calculation circuit. The light-receiving circuit includes a light-receiving element, and is configured to be able to detect a light pulse reflected by a detection target among the light pulses emitted from the light-emitting section. The conversion circuit is configured to be able to calculate a digital value corresponding to a light-receiving timing in the light-receiving circuit. The histogram generation circuit is configured to be able to generate a first histogram on a basis of the digital value. The correction processing circuit is configured to be able to generate a second histogram by performing correction processing on the first histogram using a light-receiving characteristic that is asymmetric in a direction of a time axis in the light-receiving element. The calculation circuit is configured to be able to calculate a representative value of the light-receiving timing on a basis of the second histogram.

In the photodetector and the photodetection system according to the embodiments of the present disclosure, the light-receiving circuit detects a light pulse reflected by a detection target among light pulses emitted from the light-emitting section, and the conversion circuit calculates a digital value corresponding to a light-receiving timing in the light-receiving circuit. The histogram generation circuit generates a first histogram on the basis of the digital value. The correction processing circuit generates a second histogram by performing correction processing on the first histogram using a light-receiving characteristic that is asymmetric in a direction of a time axis in the light-receiving element in the light-receiving circuit. The calculation circuit calculates a representative value of the light-receiving timing from the second histogram.

### BRIEF DESCRIPTION OF THE DRAWINGS

FIG. 1 is a block diagram illustrating a configuration example of a photodetection system according to an embodiment of the present disclosure.

FIG. 2 is a block diagram illustrating a configuration example of a photodetection unit illustrated in FIG. 1.

FIG. 3A is a circuit diagram illustrating a configuration example of a light-receiving section illustrated in FIG. 2.

FIG. 3B is a circuit diagram illustrating another configuration example of the light-receiving section illustrated in FIG. 2.

FIG. 4 is an explanatory diagram illustrating an example of a histogram inputted into a correction processing section illustrated in FIG. 2.

FIG. 5A is another explanatory diagram illustrating an example of the histogram inputted into the correction processing section illustrated in FIG. 2.

FIG. 5B is another explanatory diagram illustrating an example of the histogram inputted into the correction processing section illustrated in FIG. 2.

FIG. 6 is a block diagram illustrating a configuration example of the correction processing section illustrated in FIG. 2.

FIG. 7 is an explanatory diagram illustrating a characteristic example of a timing jitter.

FIG. 8 is an explanatory diagram illustrating a characteristic example of differential non-linearity.

FIG. 9 is another explanatory diagram illustrating a characteristic example of the differential non-linearity.

FIG. 10 is an explanatory diagram illustrating a convolution arithmetic operation of a distribution function of a timing jitter and a distribution function of differential non-linearity.

FIG. 11 is a flowchart illustrating an operation example of the correction processing section and a distance arithmetic section illustrated in FIG. 2.

FIG. 12 is an explanatory diagram illustrating an example of a histogram.

FIG. 13 is an explanatory diagram illustrating an example of a result of an arithmetic operation by the correction processing section illustrated in FIG. 2.

FIG. 14 is a characteristic diagram illustrating a characteristic example of precision of distance values.

FIG. 15 is a characteristic diagram illustrating a characteristic example of a probability of failing of distance values.

FIG. 16 is a block diagram depicting an example of schematic configuration of a vehicle control system.

FIG. 17 a diagram of assistance in explaining an example of installation positions of an outside-vehicle information detecting section and an imaging section.

### MODES FOR CARRYING OUT THE INVENTION

In the following, some embodiments of the present disclosure are described in detail with reference to the drawings. It is to be noted that the description is given in the following order.
1. Embodiment
2. Example of Application to Mobile Body

### 1. Embodiment

### Configuration Example

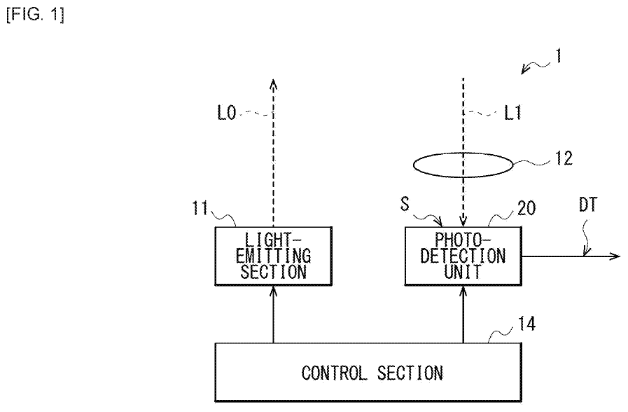

FIG. 1 illustrates a configuration example of a photodetection system according to an embodiment (a photodetection system 1). The photodetection system 1 is a ToF sensor and is configured to emit light toward a detection target, and to detect reflected light reflected by the detection target. The photodetection system 1 includes a light-emitting section 11, an optical system 12, a photodetection unit 20, and a control section 14.

The light-emitting section 11 is configured to emit a light pulse L0 toward a detection target on the basis of an instruction from the control section 14. The light-emitting section 11 performs light-emitting operation where light emission and non-light emission are alternately repeated on the basis of an instruction from the control section 14 to emit the light pulse L0. The light-emitting section 11 includes a light source that emits infrared light, for example. The light source includes a laser light source, for example.

The optical system 12 includes a lens that forms an image on a light-receiving surface S of the photodetection unit 20. The light pulse emitted from the light-emitting section 11 and reflected by the detection target (reflected light pulse L1) enters the optical system 12.

The photodetection unit 20 is configured to detect the reflected light pulse L1 on the basis of an instruction from the control section 14. The photodetection unit 20 then generates a distance image on the basis of a result of detection, and outputs image data of the generated distance image as data DT.

The control section 14 is configured to supply control signals to the light-emitting section 11 and the photodetection unit 20 and control operation thereof to control operation of the photodetection system 1.

With this configuration, the photodetection system 1 repeatedly emits the light pulse L0 and repeatedly detects the reflected light pulse L1 in accordance with the light pulse L0 to generate a histogram pertaining to a ToF value. In the photodetection system 1, a distance to the detection target is then detected on the basis of the histogram.

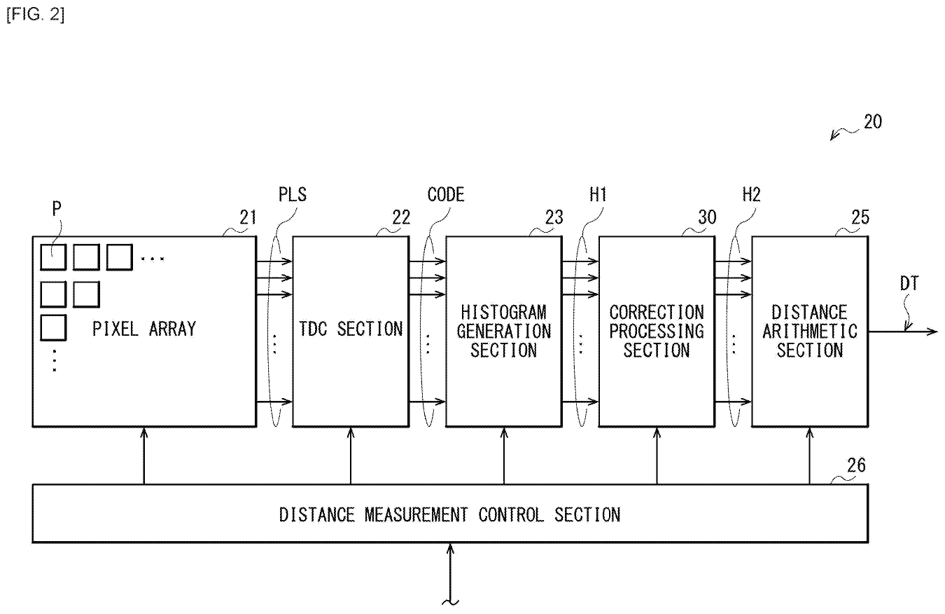

FIG. 2 illustrates a configuration example of the photodetection unit 20. The photodetection unit 20 includes a pixel array 21, a TDC (Time to Digital Converter) section 22, a histogram generation section 23, a correction processing section 30, a distance arithmetic section 25, and a distance measurement control section 26.

The pixel array 21 includes a plurality of light-receiving sections P arranged in matrix. Each of the plurality of light-receiving sections P is configured to detect the reflected light pulse L1 to generate a pulse signal PLS.

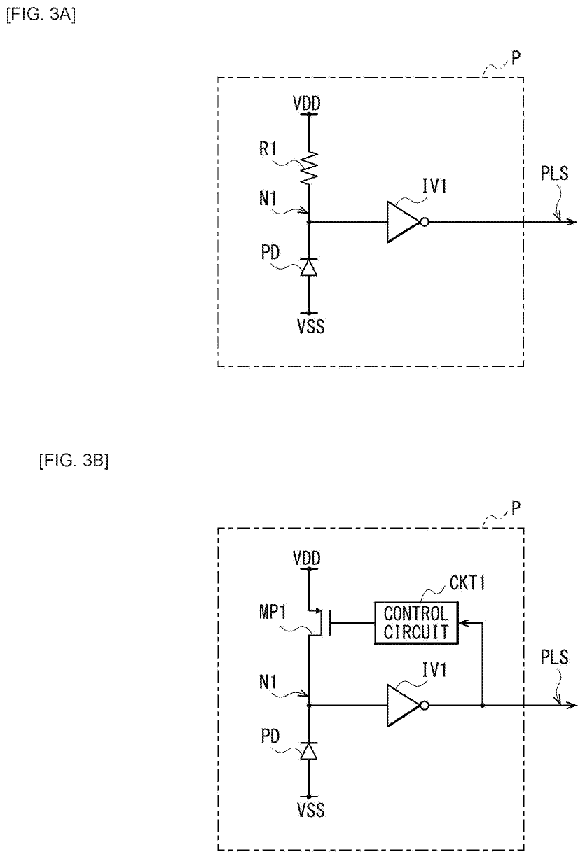

FIG. 3A illustrates a configuration example of the light-receiving section P. In this example, the light-receiving section P includes a photodiode PD, a resistance element R1, and an inverter IV1.

The photodiode PD is a photoelectric conversion element that converts light into electric charge. An anode of the photodiode PD is supplied with a power supply voltage VSS, and a cathode is coupled to a node N1. As the photodiode PD, there can be used a single photon avalanche diode (SPAD), for example.

One end of the resistance element R1 is supplied with a power supply voltage VDD, and another end is coupled to the node N1.

The inverter IV1 is configured to output a low level in a case where a voltage at the node N1 is higher than a logical threshold value, and to output a high level in a case where the voltage at the node N1 is lower than the logical threshold value to generate a pulse signal PLS.

In the light-receiving section P with this configuration, the photodiode PD detects light, whereby avalanche amplification occurs, and the voltage at the node N1 decreases. When the voltage at the node N1 falls below the logical threshold value of the inverter IV1, the pulse signal PLS then changes from the low level to the high level. Thereafter, as an electric current flows into the node N1 via the resistance element R1, the voltage at the node N1 increases. When the voltage at the node N1 exceeds the logical threshold value of the inverter IV1, the pulse signal PLS then changes from the high level to the low level. In this way, the light-receiving section P generates a pulse signal PLS having a pulse corresponding to light detected.

FIG. 3B illustrates another configuration example of the light-receiving section P. In this example, the light-receiving section P includes the photodiode PD, a transistor MP1, the inverter IV1, and a control circuit CKT1.

The transistor MP1 is a P-type MOS (metal oxide semiconductor) transistor, in which a gate is coupled to an output terminal of the control circuit CKT1, a source is supplied with the power supply voltage VDD, and a drain is coupled to the node N1.

The control circuit CKT1 is configured to control operation of the transistor MP1 on the basis of the pulse signal PLS. Specifically, the control circuit CKT1 decreases a voltage at the gate of the transistor MP1 to the low level after the pulse signal PLS is changed from the low level to the high level, and increases the voltage at the gate of the transistor MP1 to the high level after the pulse signal PLS is changed from the high level to the low level.

In the light-receiving section P with this configuration, when the photodiode PD detects light, whereby the voltage at the node N1 decreases. When the voltage at the node N1 falls below the logical threshold value of the inverter IV1, the pulse signal PLS then changes from the low level to the high level. After the pulse signal PLS has changed, the control circuit CKT1 decreases the voltage at the gate of the transistor MP1 to the low level. Thereby, the transistor MP1 comes into an on state, and an electric current flows into the node N1 via the transistor MP1, whereby the voltage at the node N1 increases. When the voltage at the node N1 exceeds the logical threshold value of the inverter IV1, the pulse signal PLS then changes from the high level to the low level. After the pulse signal PLS has changed, the control circuit CKT1 increases the voltage at the gate of the transistor MP1 to the high level. Thereby, the transistor MP1 comes into an off state. In this way, the light-receiving section P generates the pulse signal PLS having a pulse corresponding to light detected.

In the pixel array 21, a plurality of light-receiving sections P to operate among all the light-receiving sections P are sequentially selected, for example. The selected plurality of light-receiving sections P then supply pulse signals PLS to the TDC section 22.

The TDC section 22 (FIG. 2) is configured to generate a digital code CODE corresponding to a light-receiving timing in each of the light-receiving sections P on the basis of each of the plurality of pulse signals PLS supplied from the pixel array 21. The TDC section 22 includes a counter and a latch circuit, for example. For example, the counter starts to increment a count value on the basis of a light-emitting timing of the light-emitting section 11. The latch circuit then latches the count value on the basis of a rising edge of the pulse signal PLS. The latched count value corresponds to a duration (hereinafter, also referred to as a ToF value) from a light-emitting timing in the light-emitting section 11 to a light-receiving timing in the light-receiving section P. The TDC section 22 outputs the latched count value as the digital code CODE.

The histogram generation section 23 is configured to generate a histogram H1 indicating a light-receiving timing in each of the plurality of light-receiving sections P on the basis of the digital code CODE supplied from the TDC section 22. That is, the light-emitting section 11 repeatedly emits the light pulse L0, and the light-receiving section P repeatedly detects the reflected light pulse L1, thus allowing the TDC section 22 to repeatedly generate the digital code CODE. Therefore, the histogram generation section 23 generates the histogram H1 for each of the plurality of light-receiving sections P on the basis of the digital code CODE that has been repeatedly generated.

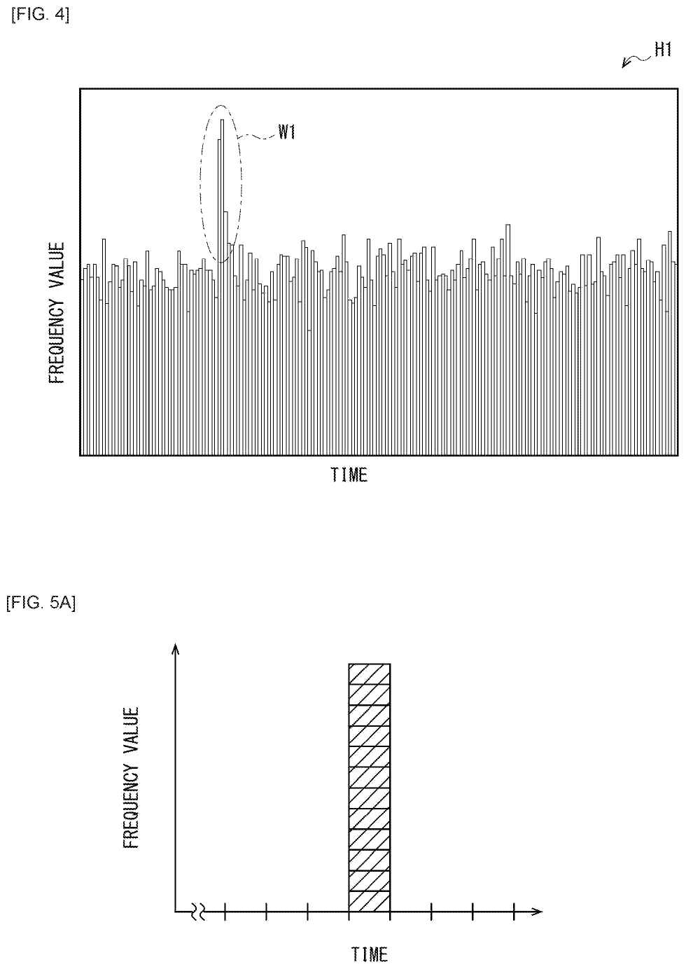

FIG. 4 illustrates an example of the histogram H1. In the histogram H1, a horizontal axis indicates time, and a vertical axis indicates a frequency value. As described above, the histogram H1 indicates a frequency value in each of a plurality of time zones (in this example, about 100 time zones). Each of the plurality of time zones corresponds to a code value of the digital code CODE.

In the example illustrated in FIG. 4, the histogram H1 has a reflected light component (a portion W1) and an ambient light component. The reflected light component is a component corresponding to the reflected light pulse L1, and is generated within a period of time corresponding to a distance from the photodetection system 1 to a measurement target. The ambient light component is a component corresponding to light entered the photodetection unit 20 from around the photodetection system 1, irrelevant to the light pulse L0 emitted from the light-emitting section 11, and is generated substantially uniformly on the time axis.

The histogram generation section 23 generates such a histogram H1 for each of the plurality of light-receiving sections P on the basis of the digital code CODE supplied from the TDC section 22.

The correction processing section 30 (FIG. 2) is configured to use an EM (Expectation Maximization) algorithm to perform correction processing on the basis of the histogram H1 generated by the histogram generation section 23 for each of the plurality of light-receiving sections P so as to remove an influence of a measurement error to thereby generate a histogram H2. That is, when the light-emitting section 11 emits the light pulse L0 on the basis of an instruction from the control section 14, for example, a response time may vary at random, thus causing a ToF value to fluctuate. Further, when the photodiode PD converts light into electric charge, for example, a response time may vary at random, thus causing a ToF value to fluctuate. Such fluctuation of a ToF value is also referred to as a timing jitter. Furthermore, when the TDC section 22 converts a light-receiving timing into the digital code CODE, differential non-linearity (DNL: Differential Non-Linearity) in conversion characteristics may cause a measurement error to be generated.

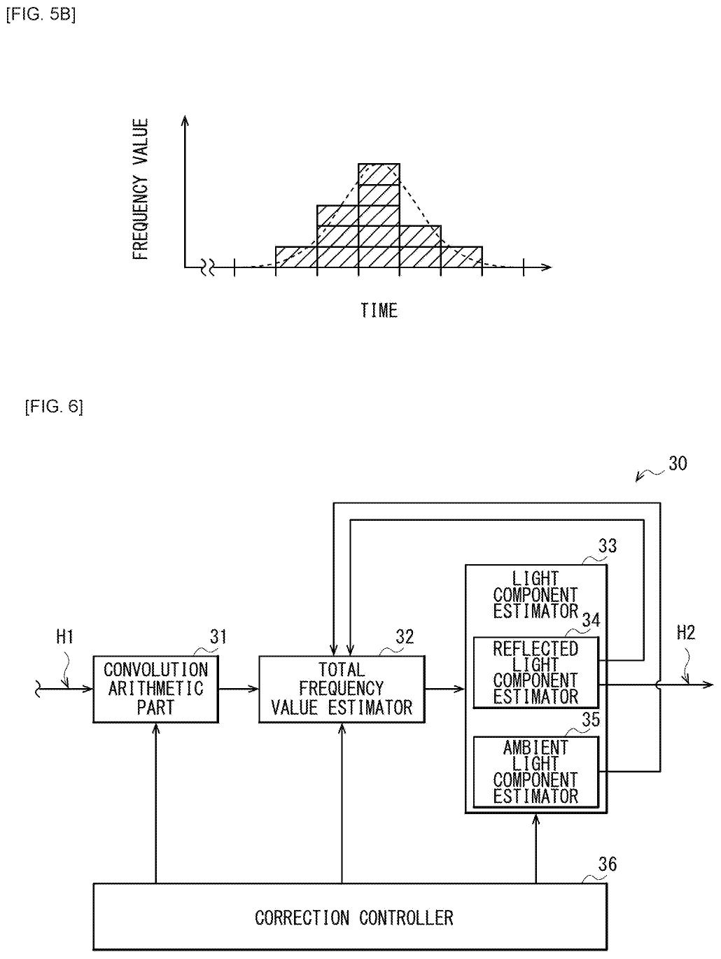

FIGS. 5A and 5B each illustrate an influence of a measurement error. In a case where there is a measurement target at a position away from the photodetection system 1 by a certain predetermined distance, for example, it is desirable that there be, in the histogram H1, a frequency value only in one time zone corresponding to the certain predetermined distance among a plurality of time zones, as illustrated in FIG. 5A. However, there are frequency values distributed across a plurality of time zones in the histogram H1 in an actual case, as illustrated in FIG. 5B. The distribution is influenced by a timing jitter or differential non-linearity, as described above.

The correction processing section 30 performs correction processing on the basis of the histogram H1 so as to remove the influence of such a timing jitter or differential non-linearity to thereby generate the histogram H2.

The distance arithmetic section 25 (FIG. 2) is configured to calculate, on the basis of the histogram H2 generated by the correction processing section 30 for each of the plurality of light-receiving sections P, a value of a distance from the photodetection system 1 to the detection target in each of the plurality of light-receiving sections P to generate a distance image. Specifically, the distance arithmetic section 25 calculates, on the basis of the histogram H2 pertaining to a certain one of the light-receiving sections P, for example, a representative value of a light-receiving timing in the certain one of the light-receiving sections P. The distance arithmetic section 25 is able to set a light-receiving timing corresponding to a peak value in the histogram H2 as a representative value of the light-receiving timing in the light-receiving section P, for example. The distance arithmetic section 25 then calculates a value of a distance from the photodetection system 1 to the detection target on the basis of the calculated representative value of the light-receiving timing. The distance arithmetic section 25 calculates a value of a distance from the photodetection system 1 to the detection target for each of the plurality of light-receiving sections P in the pixel array 21. In this way, the distance arithmetic section 25 generates a distance image including the distance values. The distance arithmetic section 25 then outputs data of the generated distance image as data DT.

The distance measurement control section 26 is configured to supply, on the basis of an instruction from the control section 14, control signals to the pixel array 21, the TDC section 22, the histogram generation section 23, the correction processing section 24, and the distance arithmetic section 25 to control operation of the photodetection unit 20.

### (Correction Processing Section 30)

FIG. 6 illustrates a configuration example of a circuit part that performs correction processing on one histogram H1 pertaining to a certain one of the light-receiving sections P, in the correction processing section 30. The correction processing section 30 includes a convolution arithmetic part 31, a total frequency value estimator 32, a light component estimator 33, and a correction controller 36.

The convolution arithmetic part 31 is configured to perform a convolution arithmetic operation on the basis of the histogram H1 and a mathematical function fₜₒₜₐₗ. The mathematical function fₜₒₜₐₗ is a distribution function indicating a timing jitter and differential non-linearity as described above.

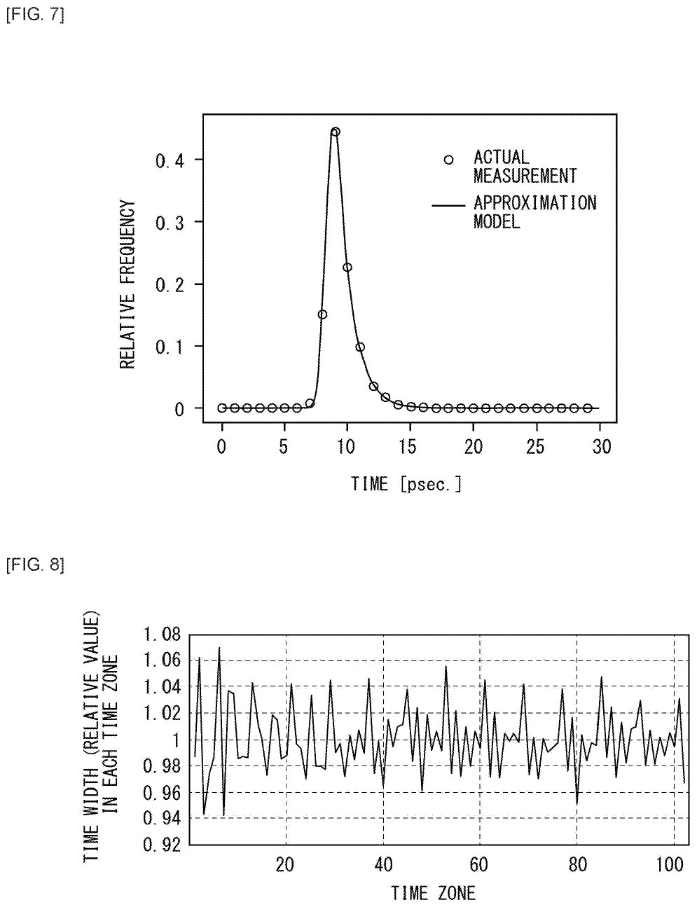

FIG. 7 illustrates an example of a timing jitter. When the light-emitting section 11 emits the light pulse L0 on the basis of an instruction from the control section 14, a response time may vary at random, thus causing a ToF value to fluctuate, as described above. Furthermore, when the photodiode PD converts light into electric charge, for example, a response time may vary at random, thus causing a ToF value to fluctuate. Such a timing jitter indicates such a profile as illustrated in FIG. 7, for example. The profile reflects a distribution of response times when the light-emitting section 11 emits the light pulse L0 on the basis of an instruction from the control section 14, and a distribution of response times when the photodiode PD converts light into electric charge. The profile has an asymmetric form in the direction of the time axis, which includes a tail part that gently decreases upon falling. The profile is represented by an expression described below using a mathematical function of probability density called EMG (Exponentially Modified Gaussian).

$${f}_{jitter} ( t \vert {μ}_{jitter} , {λ}_{jitter} , {σ}_{jitter} ) = \frac{{λ}_{jitter}}{2} \cdot exp [ {λ}_{jitter} ( \frac{{λ}_{jitter} {σ}_{jitter}^{2}}{2} + μ - t ) ] \cdot erfc [ \frac{1}{\sqrt{2}} ( {λ}_{jitter} {σ}_{jitter} + \frac{μ - t}{{σ}_{jitter}} ) ] \qquad ( EQ1 )$$

Note herein that t indicates time, erfc indicates a mathematical function of complementary error, μ is a parameter that indicates a position of the profile on the time axis, λⱼᵢₜₜₑᵣ is a parameter that indicates a shape of the tail part of the profile, and σⱼᵢₜₜₑᵣ is a parameter that indicates a width of the profile. A solid line in FIG. 7 indicates a result of fitting using the expression (EQ1). As described above, it is possible to indicate a timing jitter using the distribution function (the mathematical function fⱼᵢₜₜₑᵣ).

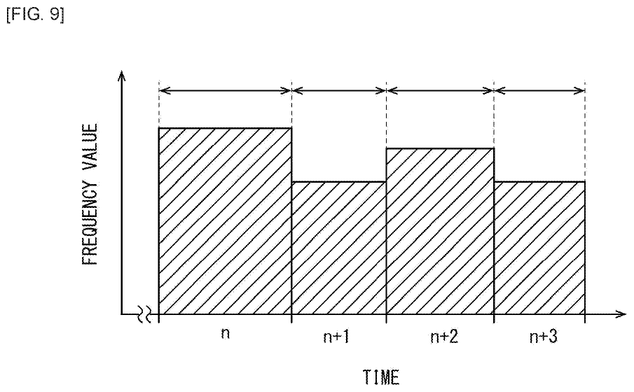

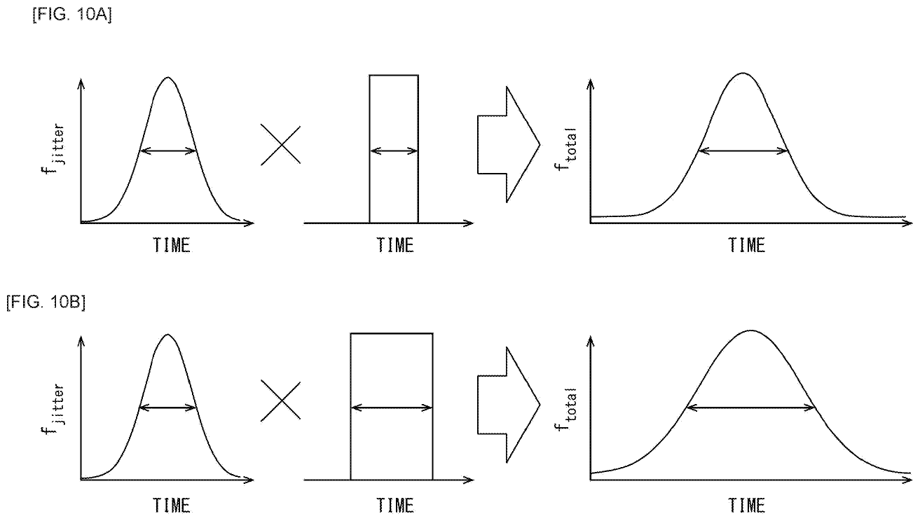

FIGS. 8 and 9 each illustrate an example of differential non-linearity in the TDC section 22. When the TDC section 22 converts a light-receiving timing into the digital code CODE, differential non-linearity in conversion characteristics may cause a measurement error to be generated, as described above. In the TDC section 22, as illustrated in FIG. 8, time widths vary among a plurality of time zones. Among a time width of an n-th time zone, a time width of an (n+1)-th time zone, a time width of an (n+2)-th time zone, and a time width of an (n+3)-th time zone in the example illustrated in FIG. 9, the time width of the n-th time zone is the widest, and the time width of the (n+2)-th time zone is the next widest. It may be said, for example, that the wider the time width of a time zone is, the greater the ambient light component becomes. Upon converting a light-receiving timing into the digital code CODE, when the light-receiving timing corresponds to a timing within a time width of a certain time zone, the TDC section 22 increments a frequency value in the certain time zone. Therefore, it is possible to regard the conversion characteristics of the TDC section 22 as indicating a distribution function of a rectangular shape where values become uniform within a time width of a time zone.

In the present technology, a timing jitter and differential non-linearity as described above are both taken into account. Specifically, as illustrated in FIG. 10, a convolution arithmetic operation is performed on the basis of a distribution function of a timing jitter (the mathematical function fⱼᵢₜₜₑᵣ) and a distribution function of differential non-linearity to define the mathematical function fₜₒₜₐₗ indicating a measurement error. The mathematical function fₜₒₜₐₗ is defined for each of the plurality of time zones. In a case where a time width of a certain time zone is narrower due to differential non-linearity, as illustrated in (A) in FIG. 10, for example, a width of the mathematical function fₜₒₜₐₗ pertaining to the certain time zone becomes narrower. Further, in a case where a time width of a certain time zone is wider due to differential non-linearity, as illustrated in (B) in FIG. 10, for example, a width of the mathematical function fₜₒₜₐₗ pertaining to the certain time zone becomes wider.

A width σ_{DNL, ij} of the distribution function of a rectangular shape is defined using an expression described below.

$${σ}_{DNL , ij} = \frac{Δ {T}_{ij}}{2 \sqrt{3}} \qquad ( EQ 2 )$$

Note herein that σ_{DNL, ij} is a standard deviation corresponding to a time width of a j-th time zone in the histogram H1 corresponding to an i-th light-receiving section P. ΔTᵢⱼ is the time width of the j-th time zone in the histogram H1 corresponding to the i-th light-receiving section P. That is, in Expression EQ2, a time width of a time zone is converted into a width σ representing a standard deviation.

It is possible to use the width σ_{DNL, ij} and an expression described below to represent the mathematical function fₜₒₜₐₗ, for example.

$$\begin{matrix}{f}_{total} ( t \vert {t}_{ij} , {λ}_{jitter} , {σ}_{jitter} , {σ}_{DNL , ij} ) = \frac{{λ}_{jitter}}{2} \cdot exp [ {λ}_{jitter} ( \frac{{λ}_{jitter} {σ}_{total , i , j}^{2}}{2} + {tb}_{ij} - t ) ] \cdot erfc [ \frac{1}{\sqrt{2}} ( {λ}_{jitter} {σ}_{total , ij} + \frac{{tb}_{ij} - t}{{σ}_{total , ij}} ) ] \\ {tb}_{ij} = {t}_{ij} - \frac{1}{{λ}_{jitter}} \\ {σ}_{total , ij} = \sqrt{{σ}_{jitter}^{2} + {σ}_{DNL , ij}^{2}}\end{matrix} \} \qquad ( EQ 3 )$$

Note herein that tᵢⱼ is a parameter that indicates time at a middle in the j-th time zone in the histogram H1 corresponding to the i-th light-receiving section P, tbᵢⱼ is a parameter that indicates a position of a center of gravity on the time axis of the mathematical function fₜₒₜₐₗ, and σₜₒₜₐₗ, ij is a parameter that indicates a width of the mathematical function fₜₒₜₐₗ.

It is possible to represent tᵢⱼ with an expression described below.

$$\begin{matrix}{t}_{ij} = \frac{Δ {T}_{ij}}{2} + {\sum }_{l = 1}^{j - 1} Δ {T}_{il} \\ Δ {T}_{i 0} = 0\end{matrix} \} \qquad ( EQ 4 )$$

That is, differential non-linearity influences the time tᵢⱼ at a middle in a plurality of time zones. Therefore, Expression EQ4 is used to calculate the time tᵢⱼ on the basis of a time width ΔTᵢⱼ of a time zone.

In the photodetection system 1, the mathematical function fₜₒₜₐₗ described above is prepared beforehand on the basis of characteristics of the light-emitting section 11, the light-receiving sections P, and the TDC section 22. The convolution arithmetic part 31 then performs a convolution arithmetic operation on the basis of the histogram H1 and the mathematical function fₜₒₜₐₗ.

The total frequency value estimator 32 (FIG. 6) is configured to estimate a total frequency value of a reflected light component and an ambient light component in each of the plurality of time zones in the histogram H1 on the basis of a result of the arithmetic operation by the convolution arithmetic part 31 and a result of an estimation by the light component estimator 33.

The light component estimator 33 is configured to estimate a reflected light component and an ambient light component in the histogram H1. The light component estimator 33 includes a reflected light component estimator 34 and an ambient light component estimator 35.

The reflected light component estimator 34 estimates a reflected light component in the histogram H1, and supplies a result of the estimation to the total frequency value estimator 32. Furthermore, the reflected light component estimator 34 further performs, on the basis of an instruction from the correction controller 36, operation of supplying the distance arithmetic section 25 (FIG. 2) with a histogram of the estimated reflected light component as the histogram H2.

The ambient light component estimator 35 estimates an ambient light component in the histogram H1, and supplies a result of the estimation to the total frequency value estimator 32.

The correction controller 36 is configured to supply control signals to the convolution arithmetic part 31, the total frequency value estimator 32, and the light component estimator 33 to control overall operation of the correction processing section 30. The correction controller 36 controls the total frequency value estimator 32 and the light component estimator 33 to repeat the processing until a predetermined determination standard is satisfied. In a case where the predetermined determination standard is satisfied, the correction controller 36 then provides the light component estimator 33 with an instruction of outputting a histogram of the estimated reflected light component as the histogram H2.

Note herein that the light-receiving section P corresponds to a specific example of a “light-receiving circuit” in the present disclosure. The photodiode PD corresponds to a specific example of a “light-receiving element” in the present disclosure. The TDC section 22 corresponds to a specific example of a “conversion circuit” in the present disclosure. The histogram generation section 23 corresponds to a specific example of a “histogram generation circuit” in the present disclosure. The correction processing section 30 corresponds to a specific example of a “correction processing circuit” in the present disclosure. The distance arithmetic section 25 corresponds to a specific example of a “calculation circuit” in the present disclosure. The light-emitting section 11 corresponds to a specific example of a “light-emitting section” in the present disclosure.

### [Operation and Workings]

Subsequently, operation and workings of the photodetection system 1 according to the present embodiment are described.

### (Outline of Overall Operation)

An outline of overall operation of the photodetection system 1 is first described with reference to FIGS. 1 and 2. The light-emitting section 11 emits the light pulse L0 toward a detection object OBJ. The optical system 12 forms an image on the light-receiving surface S of the photodetection unit 20. The photodetection unit 20 detects the reflected light pulse L1. The control section 14 supplies control signals to the light-emitting section 11 and the photodetection unit 20 and controls operation thereof to control distance measurement operation of the photodetection system 1.

In the photodetection unit 20, the light-receiving section P in the pixel array 21 detects light to generate the pulse signal PLS. The TDC section 22 generates the digital code CODE corresponding to a light-receiving timing in the light-receiving section P on the basis of each of the plurality of pulse signals PLS supplied from the pixel array 21. The histogram generation section 23 generates the histogram H1 indicating the light-receiving timing in each of the plurality of light-receiving sections P on the basis of the digital code CODE supplied from the TDC section 22. The correction processing section 30 uses the EM algorithm to perform correction processing on the basis of the histogram H1 generated by the histogram generation section 23 for each of the plurality of light-receiving sections P to remove an influence of a measurement error to generate the histogram H2. The distance arithmetic section 25 calculates, on the basis of the histogram H2 generated by the correction processing section 30 for each of the plurality of light-receiving sections P, a value of a distance from the photodetection system 1 to the detection target in each of the plurality of light-receiving sections P to generate a distance image. The distance measurement control section 26 supplies, on the basis of an instruction from the control section 14, control signals to the pixel array 21, the TDC section 22, the histogram generation section 23, the correction processing section 24, and the distance arithmetic section 25 to control operation of the photodetection unit 20.

### (Detailed Operation)

Next, operation of calculating a distance value on the basis of the histogram H1 that the histogram generation section 23 generates is described in detail.

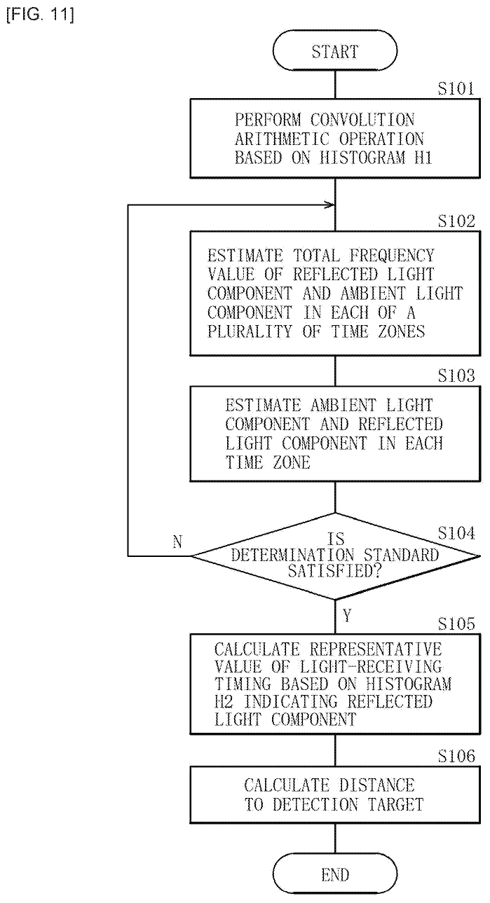

FIG. 11 illustrates an example of operation of calculating a distance value on the basis of the histogram H1. The correction processing section 30 uses the EM algorithm to perform correction processing on the basis of the histogram H1 to remove an influence of a measurement error to generate the histogram H2. The distance arithmetic section 25 calculates a value of a distance from the photodetection system 1 to the detection target on the basis of the histogram H2. This operation is described below in detail.

The convolution arithmetic part 31 in the correction processing section 30 first performs convolution arithmetic operation on the basis of the histogram H1 and the mathematical function fₜₒₜₐₗ (step S101).

Next, the total frequency value estimator 32 estimates a total frequency value of a reflected light component and an ambient light component in each of the plurality of time zones in the histogram H1 on the basis of a result of the arithmetic operation by the convolution arithmetic part 31 and a result of an estimation by the light component estimator 33 (step S102).

Next, the light component estimator 33 estimates an ambient light component and a reflected light component in each of the plurality of time zones (step S103).

Next, the correction controller 36 confirms whether or not the predetermined determination standard is satisfied (step S104). The predetermined determination standard may be, for example, whether or not the number of times of arithmetic operations that the total frequency value estimator 32 and the light component estimator 33 have performed reaches the predetermined number of times, or whether or not results of estimations by the total frequency value estimator 32 and the light component estimator 33 have been converged. In a case where the predetermined determination standard has not been satisfied (“N” in step S104), the processing returns to step S102. Thereby, the correction processing section 30 repeats step S102 to step S104 in the processing until the predetermined determination standard is satisfied. In a case where the predetermined determination standard has been satisfied (“Y” in step S104), the correction processing section 30 ends steps S102 and S103 in the processing. The light component estimator 33 then outputs a histogram of the estimated reflected light component as the histogram H2.

Next, the distance arithmetic section 25 calculates a representative value of a light-receiving timing on the basis of the histogram H2 (step S105). For example, the distance arithmetic section 25 is able to set a light-receiving timing corresponding to a peak value in the histogram H2 as a representative value of the light-receiving timing in the light-receiving section P.

The distance arithmetic section 25 then calculates a value of a distance from the photodetection system 1 to the detection target on the basis of the calculated representative value of the light-receiving timing (step S106).

Then the processing ends.

Next, the processing illustrated in FIG. 11 is specifically described.

### (About Step S101)

The convolution arithmetic part 31 in the correction processing section 30 first performs a convolution arithmetic operation on the basis of the histogram H1 and the mathematical function fₜₒₜₐₗ. In this example, the histogram H1 is a histogram pertaining to the i-th light-receiving section P, and includes frequency values N_{i, 1}, N_{i, 2}, N_{i, 3}, . . . , N_{i, Nbin} in an Nbin number of time segments. The convolution arithmetic part 31 uses an expression described below to perform a convolution arithmetic operation to calculate a frequency value Nᵢₖ^{conv}.

$${N}_{ik}^{conv} = {\sum }_{j = 1}^{Nbin} {N}_{ij} {F}_{ijk} \qquad ( EQ 5 )$$

Note herein that Nᵢⱼ indicates a frequency value in a j-th time segment, which is included in the histogram H1 pertaining to the i-th light-receiving section P. Nbin is the number of the plurality of time segments in the histogram H1. Nᵢₖ^{conv} is a frequency value after performing the convolution arithmetic operation in a k-th time zone pertaining to the i-th light-receiving section P. Fᵢⱼₖ is a weighting factor indicating a timing jitter and differential non-linearity, and is represented by an expression described below.

$${F}_{ijk} = {\int }_{{t}_{ik} - \frac{Δ {T}_{ik}}{2}}^{{t}_{ik} + \frac{Δ {T}_{ik}}{2}} {f}_{total} ( t \vert {t}_{ij} , {λ}_{jitter} , {σ}_{jitter} , {σ}_{DNL , ij} ) dt \qquad ( EQ6 )$$

Expression EQ6 indicates that an integration of the mathematical function fₜₒₜₐₗ indicated in Expression EQ3 is performed across a time width ΔTᵢₖ in the k-th time zone pertaining to the i-th light-receiving section P.

In this way, the convolution arithmetic part 31 performs a convolution arithmetic operation using Expressions EQ5 and EQ6 to calculate a frequency value Nᵢₖ^{conv}.

### (About Step S102 for the First Time)

Next, the total frequency value estimator 32 estimates a total frequency value of a reflected light component and an ambient light component in each of the plurality of time zones in the histogram H1 on the basis of a result of the arithmetic operation by the convolution arithmetic part 31 and a result of an estimation by the light component estimator 33.

As illustrated in FIG. 11, the total frequency value estimator 32 repeats an arithmetic operation a plurality of times. A result of an estimation by the light component estimator 33 has not yet been generated for the first time, and thus the total frequency value estimator 32 sets the frequency value Nᵢₖ^{conv} calculated in step S101 as a total frequency value Λᵢₖ⁽¹⁾, as illustrated in an expression described below.

$${∧}_{ik}^{( 1 )} = {N}_{ik}^{conv} \qquad ( EQ7 )$$

Note herein that Λᵢₖ⁽¹⁾ is a total frequency value of a reflected light component and an ambient light component in the k-th time zone pertaining to the i-th light-receiving section P in an arithmetic operation for the first time.

### (About Step S103 for the First Time)

Next, the light component estimator 33 estimates an ambient light component and a reflected light component in each of the plurality of time zones.

As illustrated in FIG. 11, the light component estimator 33 repeats an arithmetic operation a plurality of times. At the first time, the light component estimator 33 estimates an ambient light component and a reflected light component on the basis of the histogram H1, for example. The histogram H1 (FIG. 4) includes a reflected light component (portion W1) and an ambient light component, for example. Therefore, the light component estimator 33 identifies a reflected light component and an ambient light component on the basis of the frequency values N_{i, 1}, N_{i, 2}, N_{i, 3}, . . . , N_{i, Nbin} in the Nbin number of time segments in the histogram H1. The light component estimator 33 then estimates a frequency value μᵢ⁽¹⁾ per unit time on the basis of the frequency value in the ambient light component. The frequency value μᵢ⁽¹⁾ indicates a frequency value, per unit time, of the ambient light component in an arithmetic operation for the first time. Further, the light component estimator 33 estimates a frequency value λᵢₖ⁽¹⁾ on the basis of the frequency value in the reflected light component. The frequency value Λᵢₖ⁽¹⁾ is a frequency value of the reflected light component in the k-th time zone pertaining to the i-th light-receiving section P in the arithmetic operation for the first time.

The correction controller 36 then confirms whether or not the predetermined determination standard is satisfied in step S104. In a case where the predetermined determination standard has not been satisfied (“N” in step S104), the correction processing section 30 performs again steps S102 and S103 in the processing.

### (About Step S102 for the Second Time and Later Times)

Next, the total frequency value estimator 32 estimates a total frequency value of the reflected light component and the ambient light component in each of the plurality of time zones in the histogram H1 on the basis of a result of the arithmetic operation by the convolution arithmetic part 31 and a result of an estimation by the light component estimator 33.

The total frequency value estimator 32 uses an expression described below to perform an arithmetic operation for an m-th time to thereby estimate a total frequency value Λᵢₖ^{(m)}.

$$\begin{matrix}{∧}_{ik}^{( m )} = {k}_{ik}^{( m - 1 )} ( {λ}_{ik}^{( m - 1 )} + Δ {T}_{ik} {μ}_{i}^{( m - 1 )} ) \cdot {N}_{ik}^{conv} \\ {K}_{ik}^{( m - 1 )} = \frac{{\sum }_{j = 1}^{Nbin} {N}_{ij}}{{\sum }_{j = 1}^{Nbin} ( {λ}_{i n}^{( m - 1 )} + Δ {T}_{i n} {μ}_{i}^{( m - 1 )} ) {N}_{i n}^{conv}} \\ m ≧ 2\end{matrix} \} \qquad ( EQ8 )$$

Note herein that Λᵢₖ^{(m)} is a total frequency value of the reflected light component and the ambient light component in the k-th time zone pertaining to the i-th light-receiving section P in an arithmetic operation for the m-th time. λᵢₖ^{(m-1)} is a frequency value of the reflected light component in the k-th time segment pertaining to the i-th light-receiving section P in an arithmetic operation for an (m−1)-th time. μᵢ^{(m-1)} indicates a frequency value, per unit time, of the ambient light component in the arithmetic operation for the (m−1)-th time. ΔTᵢₖ is a time width of the k-th time segment pertaining to the i-th light-receiving section P, and thus ΔTᵢₖμᵢ^{(m-1)} is a frequency value of the ambient light component in the k-th time segment pertaining to the i-th light-receiving section P. Kᵢₖ^{(m-1)} is a factor used to perform an adjustment to prevent the estimated total frequency value Λᵢₖ⁽¹⁾ from being diverted from the frequency value Nix in the histogram H1.

The total frequency value estimator 32 estimates, in an arithmetic operation for the m-th time, for example, the total frequency value Λᵢₖ^{(m)} on the basis of the frequency value Λᵢₖ^{(m-1)} and the frequency value μᵢ^{(m-1)} estimated in the arithmetic operation for the (m−1)-th time (step S103). For example, the total frequency value estimator 32 estimates, in an arithmetic operation for the second time, a total frequency value Λᵢₖ⁽²⁾ on the basis of the frequency value λᵢₖ⁽¹⁾ and the frequency value μᵢ⁽¹⁾ estimated in the arithmetic operation for the first time (step S103).

### (About Step S104 for the Second Time and Later Times)

Next, the light component estimator 33 estimates an ambient light component and a reflected light component in each of the plurality of time zones.

The ambient light component estimator 35 in the light component estimator 33 first uses an expression described below to perform an arithmetic operation for the m-th time to thereby estimate a frequency value μᵢ^{(m)}, per unit time, of the ambient light component.

$${μ}_{i}^{( m )} = \frac{{\sum }_{j ∈ {J}_{NF}} {N}_{ij}}{{\sum }_{j ∈ {J}_{NF}} Δ {T}_{ij}} \cdot \frac{{\sum }_{j = 1}^{Nbin} {∧}_{ij}^{( m )}}{{\sum }_{j = 1}^{Nbin} {N}_{ij}} \qquad ( EQ9 )$$

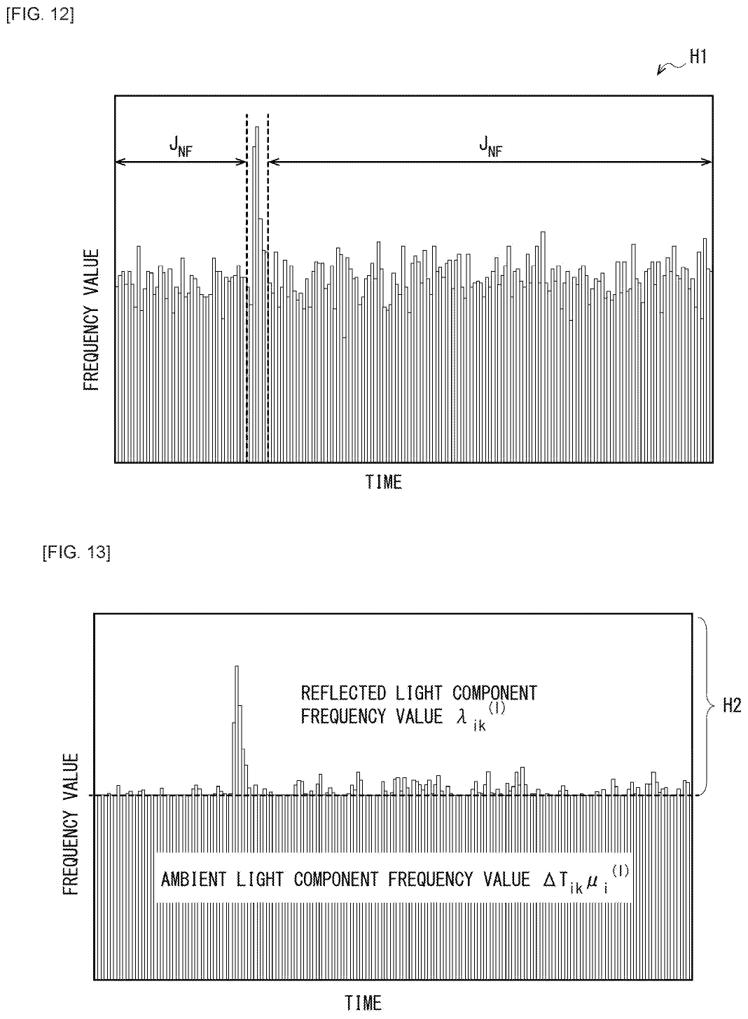

Note herein that J_{NF} indicates a time segment other than time segments around a peak among the plurality of time segments in the histogram H1, as illustrated in FIG. 12. That is, j∈J_{NF} indicates an aggregation of time segments each including only an ambient light component. Therefore, Σj∈J_{NF}Nᵢⱼ in a numerator in Expression EQ9 indicates a total of frequency values of the ambient light component on the time axis. Then, Σⱼ∈J_{NF}ΔTᵢⱼ in a denominator in Expression EQ9 indicates a total value of durations of the time segments each including only the ambient light component. Therefore, a first part (ΣNᵢⱼ/ΣΔTᵢⱼ) in Expression EQ9 indicates a frequency value, per unit time, of the ambient light component. Then, a second part (ΣΛᵢⱼ^{(m)}/ΣNᵢⱼ) in Expression EQ9 indicates a ratio between a sum of the total frequency values Λ_{i, 1}^{(m)}, Λ_{i, 2}^{(m)}, Λ_{i, 3}^{(m)}, . . . , Λ_{i, Nbin}^{(m)} estimated by the total frequency value estimator 32 and a sum of the frequency values N_{i, 1}, N_{i, 2}, N_{i, 3}, . . . , N_{i, Nbin} in the histogram H1 to serve as a factor for adjusting a frequency value, per unit time, of the ambient light component.

In this way, the ambient light component estimator 35 estimates a frequency value μᵢ^{(m)}, per unit time, of the ambient light component. For example, it is possible to use the frequency value μᵢ^{(m)} to represent a frequency value of the ambient light component in the k-th time segment by ΔTᵢₖμᵢ^{(m)}.

Further, the reflected light component estimator 34 in the light component estimator 33 uses an expression described below to perform an arithmetic operation for the m-th time to thereby estimate a frequency value λᵢₖ^{(m)} of the reflected light component.

$${λ}_{ik}^{( m )} = \{ \begin{matrix}{∧}_{ik}^{( m )} - Δ {T}_{ik} {μ}_{i}^{( m )} , & {∧}_{ik}^{( m )} > Δ {T}_{ik} {μ}_{i}^{( m )} \\ 0 , & otherwise\end{matrix} \qquad ( EQ 10 )$$

In a case where the total frequency value Λᵢₖ^{(m)} in the k-th time segment is greater than a frequency value ΔTᵢₖμᵢ^{(m)} of the ambient light component in the k-th time segment, as illustrated in Expression EQ10, the reflected light component estimator 34 calculates a difference between the frequency values to estimate the frequency value λᵢₖ^{(m)} of the reflected light component.

The correction processing section 30 repeats steps S103 and S104 in the processing as described above until the predetermined determination standard is satisfied. In a case where the predetermined determination standard has been satisfied after the correction processing section 30 has performed arithmetic operations m times (“Y” in step S104), the light component estimator 33 then acquires estimated frequency values λ_{i, 1}^{(m)}, λ_{i, 2}^{(m)}, λ_{i, 3}^{(m)}, . . . , λ_{i, Nbin}^{(m)} of the reflected light component.

FIG. 13 illustrates an example of a result of an arithmetic operation by the correction processing section 30. The correction processing section 30 performs the arithmetic operations m times to estimate frequency values λ_{i, 1}^{(m)}, λ_{i, 2}^{(m)}, λ_{i, 3}^{(m)}, . . . , λ_{i, Nbin}^{(m)} of the reflected light component and frequency values ΔT_{i, 1}μᵢ^{(m)}, ΔT_{i, 2}μᵢ^{(m)}, ΔT_{i, 3}μᵢ^{(m)}, . . . , ΔT_{i, Nbin}μᵢ^{(m)}of the ambient light component. In this example, frequency values in the ambient light component become more even, as compared with those in the histogram H1 (FIG. 12). The light component estimator 33 outputs a histogram including the frequency values λ_{i, 1}^{(m)}, λ_{i, 2}^{(m)}, λ_{i, 3}^{(m)}, . . . , λ_{i, Nbin}^{(m)} of the reflected light component as the histogram H2 of the i-th light-receiving section P.

### (About Steps S105 and S106)

Next, the distance arithmetic section 25 calculates a representative value of a light-receiving timing on the basis of the histogram H2. For example, the distance arithmetic section 25 is able to set a light-receiving timing corresponding to a peak value in the histogram H2 as a representative value of the light-receiving timing in the light-receiving section P.

The distance arithmetic section 25 then calculates a value of a distance from the photodetection system 1 to the detection target on the basis of the calculated representative value of the light-receiving timing.

### (About Experiments)

Next, results of experiments on the photodetection system 1 are described.

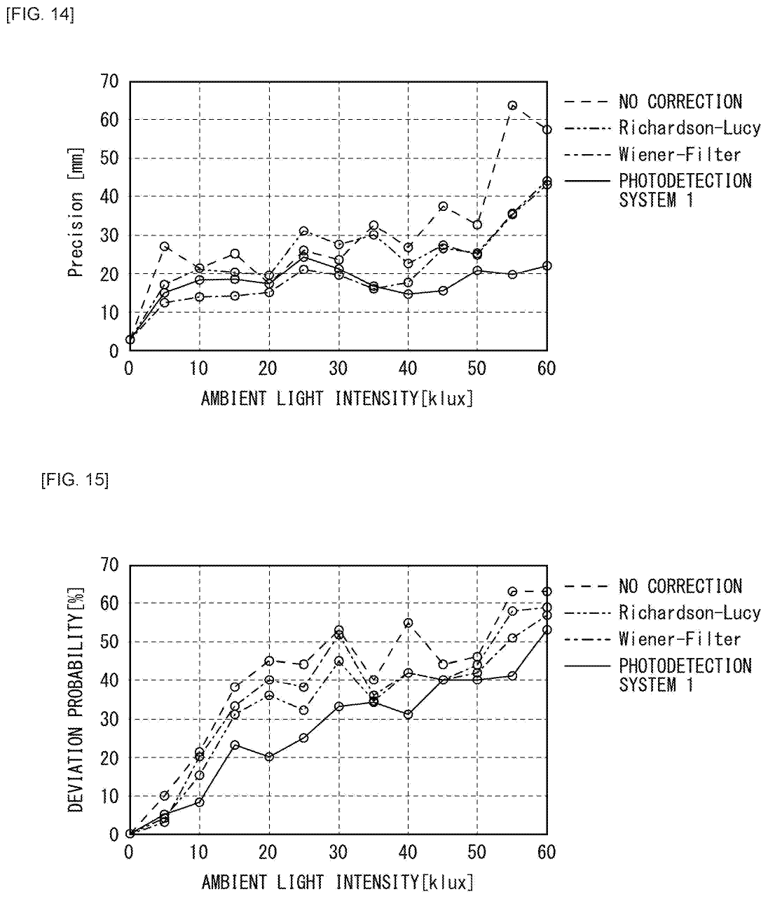

FIG. 14 illustrates a characteristic example about precision of distance values acquired by a photodetection system. FIG. 14 illustrates, in a case where a measurement target is placed at a position 10 m away from the photodetection system, a gap of a distance value acquired by the photodetection system from an actual distance value (10 m). In this experiment, an intensity of ambient light is changed within a range from 0 klux to 60 klux inclusive. FIG. 14 plots a result of a measurement in a case where correction processing is not performed on the histogram H1, a result of a measurement in a case where correction processing is performed using a Richardson-Lucy method described in PTL 1, a result of a measurement in a case where correction processing is performed using a Wiener-Filter method described in PTL 1, and a result of a measurement of the photodetection system 1 according to the present embodiment. In the photodetection system 1 according to the present embodiment, it is possible to keep its precision to a value of about 20 mm in all intensities of ambient light. In particular, in the photodetection system 1, it is possible to reduce a gap in distance values under a condition where the intensity of ambient light is equal to or higher than 40 klux, as compared with other methods. In the photodetection system 1, it is possible to increase robustness under a condition where the intensity of ambient light is higher, as described above.

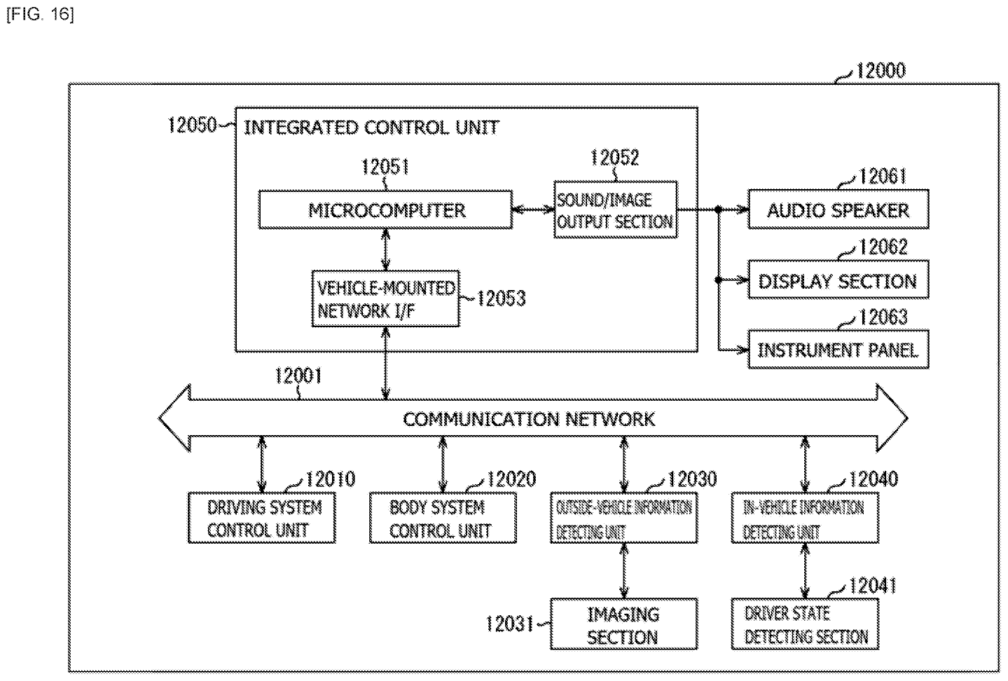

FIG. 15 illustrates a characteristic example about a probability of deviation in a distance value acquired by a photodetection system from an actual distance value. FIG. 15 illustrates, in a case where a measurement target is placed at a position 10 m away from the photodetection system, a probability of deviation in a distance value acquired by the photodetection system by 1.5% or higher from an actual distance value. In this experiment, an intensity of ambient light is changed within a range from 0 klux to 60 klux inclusive. FIG. 15 plots a result of a measurement in a case where correction processing is not performed on the histogram H1, a result of a measurement in a case where correction processing is performed using the Richardson-Lucy method described in PTL 1, a result of a measurement in a case where correction processing is performed using the Wiener-Filter method described in PTL 1, and a result of a measurement of the photodetection system 1 according to the present embodiment. In the photodetection system 1 according to the present embodiment, it is possible to lower the deviation probability in all the intensities of ambient light, as compared with other methods. In the photodetection system 1 according to the present embodiment, it is possible to acquire a correct distance value, as described above.

As described above, the photodetection system 1 includes: the light-receiving section P that includes the photodiode PD, and that is able to detect a light pulse reflected by a detection target among light pulses emitted from the light-emitting section 11; the TDC section 22 that is able to calculate the digital code CODE corresponding to a light-receiving timing in the light-receiving section P; the histogram generation section 23 that is able to generate a first histogram (the histogram H1) on the basis of the digital code CODE; the correction processing section 30 that is able to use a light-receiving characteristic (the mathematical function fⱼᵢₜₜₑᵣ) that is asymmetric in the direction of the time axis in the photodiode PD to perform correction processing on the first histogram (the histogram H1) to thereby generate a second histogram (the histogram H2); and the distance arithmetic section 25 that is able to calculate a representative value of the light-receiving timing on the basis of the second histogram (the histogram H2). Thereby, in the photodetection system 1, it is possible to perform correction processing on the first histogram (the histogram H1) so as to remove a component due to the light-receiving characteristic that is asymmetric in the direction of the time axis in the photodiode PD, thus making it possible to increase detection accuracy.

Further, in the photodetection system 1, the correction processing section 30 is able to further use a linearity characteristic in the TDC section 22, in addition to the light-receiving characteristic, to perform correction processing to thereby generate the second histogram (the histogram H2). The linearity characteristic includes a characteristic of differential non-linearity, for example. Thereby, in the photodetection system 1, it is possible to perform correction processing on the first histogram (the histogram H1) so as to remove a component due to a conversion characteristic in the TDC section 22, thus making it possible to increase detection accuracy.

### [Effects]

In the present embodiment, as described above, there are provided: the light-receiving section that includes the photodiode, and that is able to detect a light pulse reflected by a detection target among light pulses emitted from a light-emitting section; the TDC section that is able to calculate a digital code corresponding to a light-receiving timing in the light-receiving section; the histogram generation section that is able to generate a first histogram on the basis of the digital code; the correction processing section that is able to use a light-receiving characteristic that is asymmetric in the direction of the time axis in the photodiode to perform correction processing on the first histogram to thereby generate a second histogram; and the distance arithmetic section that is able to calculate a representative value of the light-receiving timing on the basis of the second histogram, thus making it possible to increase detection accuracy.

In the present embodiment, the correction processing section is able to further use a linearity characteristic in the TDC section, in addition to the light-receiving characteristic, to perform correction processing to thereby generate a second histogram. The linearity characteristic includes a characteristic of differential non-linearity, for example. Thereby, it is possible to increase detection accuracy.

### 2. Example of Application to Mobile Body

The technology (the present technology) according to the present disclosure is applicable to a variety of products. For example, the technology according to the present disclosure may be achieved as an apparatus to be installed aboard any type of mobile body such as an automobile, an electric vehicle, a hybrid electric vehicle, a motorcycle, a bicycle, a personal mobility, an airplane, a drone, a vessel, or a robot.

FIG. 16 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 16, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 16, an audio speaker 12061, a display section 12062, and an instrument panel 12063 are illustrated as the output device. The display section 12062 may, for example, include at least one of an on-board display and a head-up display.

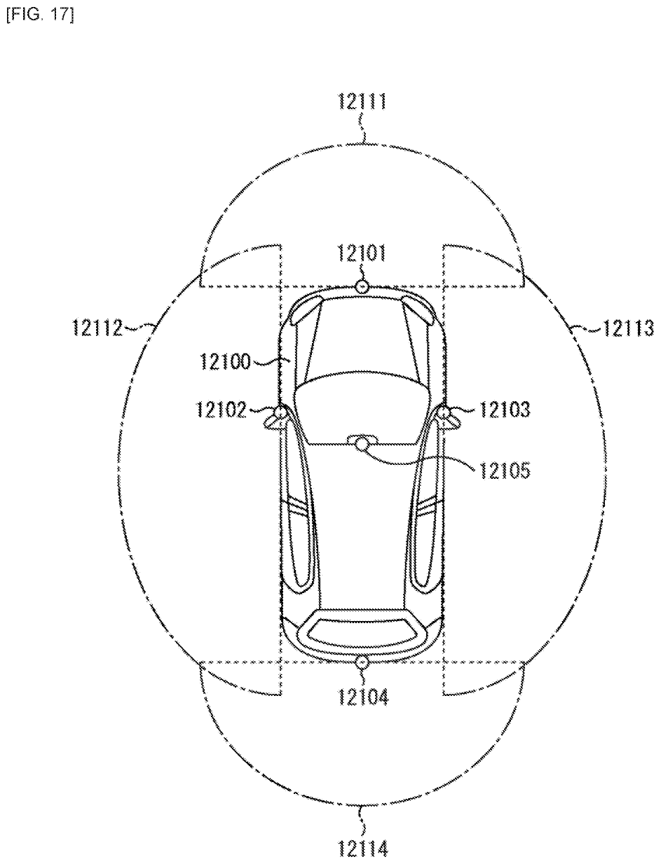

FIG. 17 is a diagram depicting an example of the installation position of the imaging section 12031.

In FIG. 17, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 17 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to the imaging section 12031 among the above-described components. This makes it possible, in the vehicle control system 12000, to increase accuracy of detecting time (a ToF value) and a distance. As a result, it is possible for the vehicle control system 12000 to achieve, with high accuracy, a collision avoidance or collision mitigation function for the vehicle, a following driving function based on vehicle-to-vehicle distance, a vehicle speed maintaining driving function, a warning function against collision of the vehicle, a warning function against deviation of the vehicle from a lane, and the like.

Although the present technology has been described above with reference to the embodiment and the specific application example thereof, the present technology is not limited to the embodiment and the like, and may be modified in a wide variety of ways.

For example, although the light-receiving sections P as illustrated in FIGS. 3A and 3B are provided in the embodiment described above, the circuit configurations of the light-receiving sections P are not limited thereto, and various types of circuit configurations are applicable.

It is to be noted that the effects described in the present specification are merely exemplary and non-limiting, and other effects may also be achieved.

It is to be noted that the technology of the present disclosure may have the following configurations. According to the technology of the following configurations, it is possible to increase detection accuracy.

(1)

A photodetector including:
a light-receiving circuit including a light-receiving element, and being configured to detect a light pulse reflected by a detection target among light pulses emitted from a light-emitting section;
a conversion circuit being configured to calculate a digital value corresponding to a light-receiving timing in the light-receiving circuit;
a histogram generation circuit being configured to generate a first histogram on a basis of the digital value;
a correction processing circuit being configured to generate a second histogram by performing correction processing on the first histogram using a light-receiving characteristic that is asymmetric in a direction of a time axis in the light-receiving element; and
a calculation circuit being configured to calculate a representative value of the light-receiving timing on a basis of the second histogram.
   (2)

The photodetector according to (1), in which the correction processing section is configured to generate the second histogram by performing the correction processing further using a linearity characteristic in the conversion circuit, in addition to the light-receiving characteristic.

(3)

The photodetector according to (2), in which the linearity characteristic includes a characteristic of differential non-linearity.

(4)

The photodetector according to (2) or (3), in which the correction processing circuit is configured to perform the correction processing by performing a convolution arithmetic operation on a basis of the first histogram and a characteristic mathematical function including the light-receiving characteristic and the linearity characteristic.

(5)

The photodetector according to any one of (1) to (4), in which
the correction processing circuit is configured to estimate, by the correction processing, a reflected light component corresponding to light reflected by the detection target and an ambient light component on a basis of the first histogram, and
the correction processing circuit is configured to generate the second histogram on a basis of the reflected light component among the reflected light component and the ambient light component.
   (6)

The photodetector according to any one of (1) to (5), in which the light-receiving characteristic includes a characteristic indicating a distribution of response times when the light-receiving element converts light into electric charge.

(7)

The photodetector according to any one of (1) to (6), in which the calculation circuit is configured to calculate a distance from the photodetector to the detection target on a basis of the representative value of the light-receiving timing.

(8)

The photodetector according to any one of (1) to (7), in which the light-receiving element includes an SPAD.

(9)

A photodetection system including:
a light-emitting section being configured to emit light pulses; and
a photodetection section,
the photodetection section including
   a light-receiving circuit including a light-receiving element, and being configured to detect a light pulse reflected by a detection target among the light pulses emitted from the light-emitting section,
   a conversion circuit being configured to calculate a digital value corresponding to a light-receiving timing in the light-receiving circuit,
   a histogram generation circuit being configured to generate a first histogram on a basis of the digital value,
   a correction processing circuit being configured to generate a second histogram by performing correction processing on the first histogram using a light-receiving characteristic that is asymmetric in a direction of a time axis in the light-receiving element, and
   a calculation circuit being configured to calculate a representative value of the light-receiving timing on a basis of the second histogram.

The present application claims the benefit of Japanese Priority Patent Application JP2021-083437 filed with the Japan Patent Office on May 17, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A photodetector comprising:
a light-receiving circuit including a light-receiving element, and being configured to detect a light pulse reflected by a detection target among light pulses emitted from a light-emitting section;
a conversion circuit being configured to calculate a digital value corresponding to a light-receiving timing in the light-receiving circuit;
a histogram generation circuit being configured to generate a first histogram on a basis of the digital value;
a correction processing circuit being configured to generate a second histogram by performing correction processing on the first histogram using a light-receiving characteristic that is asymmetric in a direction of a time axis in the light-receiving element; and
a calculation circuit being configured to calculate a representative value of the light-receiving timing on a basis of the second histogram.

2. The photodetector according to claim 1, wherein the correction processing section is configured to generate the second histogram by performing the correction processing further using a linearity characteristic in the conversion circuit, in addition to the light-receiving characteristic.

3. The photodetector according to claim 2, wherein the linearity characteristic includes a characteristic of differential non-linearity.

4. The photodetector according to claim 2, wherein the correction processing circuit is configured to perform the correction processing by performing a convolution arithmetic operation on a basis of the first histogram and a characteristic mathematical function including the light-receiving characteristic and the linearity characteristic.

5. The photodetector according to claim 1, wherein
the correction processing circuit is configured to estimate, by the correction processing, a reflected light component corresponding to light reflected by the detection target and an ambient light component on a basis of the first histogram, and
the correction processing circuit is configured to generate the second histogram on a basis of the reflected light component among the reflected light component and the ambient light component.

6. The photodetector according to claim 1, wherein the light-receiving characteristic includes a characteristic indicating a distribution of response times when the light-receiving element converts light into electric charge.

7. The photodetector according to claim 1, wherein the calculation circuit is configured to calculate a distance from the photodetector to the detection target on a basis of the representative value of the light-receiving timing.

8. The photodetector according to claim 1, wherein the light-receiving element includes an SPAD.

9. A photodetection system comprising:
a light-emitting section being configured to emit light pulses; and
a photodetection section,
the photodetection section including
a light-receiving circuit including a light-receiving element, and being configured to detect a light pulse reflected by a detection target among the light pulses emitted from the light-emitting section,
a conversion circuit being configured to calculate a digital value corresponding to a light-receiving timing in the light-receiving circuit,
a histogram generation circuit being configured to generate a first histogram on a basis of the digital value,
a correction processing circuit being configured to generate a second histogram by performing correction processing on the first histogram using a light-receiving characteristic that is asymmetric in a direction of a time axis in the light-receiving element, and
a calculation circuit being configured to calculate a representative value of the light-receiving timing on a basis of the second histogram.
